(19) United States
(12) Patent Application Publication
(10) Pub. No.: US 2009/0129110 A1
(43) Pub. Date: May 21, 2009

(54) MOTOR VEHICLE HEADLAMP WITH BETTER ABILITY TO BE RECYCLED

(75) Inventor: Paul Henri Matha, Guyancourt (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 12/298,093

(22) PCT Filed: Mar. 27, 2007
(86) PCT No.: PCT/FR07/51022

§ 371 Date: Oct. 24, 2008

(30) Foreign Application Priority Data
Apr. 25, 2006 (FR) 0651439

(51) Int. Cl. F21S 8/10

(52) U.S. Cl. 362/545

(57) ABSTRACT

A motor vehicle headlamp including a housing containing an illuminating mechanism and at least one attached element held against a front face of a back wall of the housing. A portion of the back wall that bears the attached element is at least partially delimited by a rupture-initiating zone.

The invention relates to a motor vehicle headlamp comprising a housing containing lighting means and at least one attached component held against a front face of an end wall of the housing.

Since existing and future standards require greater recyclability of vehicles, it has become increasingly necessary for the various components of the vehicle to be able to be separated from one another in order to sort them by material before recycling. This requirement also applies to headlamps formed from various parts made of different materials.

More particularly, motor vehicle headlamps in which the lighting means comprise light-emitting diodes (LEDs) have power supply means for said diodes comprising a printed circuit board which is generally borne by a headlamp housing.

However, in the case of LED lights, more particularly the taillights, it is difficult to separate the printed circuit board from the rest of the light, and as a result it is complicated and costly, or even impossible, to recycle these lights.

To alleviate these drawbacks, the subject of the invention is a headlamp which comprises at least one attached component which needs to be separated from the rest of the headlamp and has a better recyclability.

The subject of the invention is also a method for separating components of the headlamp both simply and rapidly.

To this effect, the invention provides a motor vehicle headlamp of the abovementioned type, characterized in that the portion of the end wall bearing the attached component is at least partly delimited by a fracture initiation area.

According to other features of the invention:
the fracture initiation area consists of a thinning of the thickness of the end wall;
the lighting means are LEDs and the attached component is a printed circuit board forming part of the power supply means for the diodes; and
since the attached component is located in an indentation in the end wall, the fracture initiation area is formed by at least one edge of the indentation.

The invention likewise provides a method for separating components of a headlamp, characterized in that in a first step the headlamp is detached from the vehicle, in a second step a force is applied to the rear face of the end wall of the housing, near the attached component, until the fracture initiation area gives way, and in a third step the attached component is withdrawn from the housing through the opening created in the rear of the end wall of the housing.

According to another feature of the invention, in the second step the fracture initiation area is struck directly.

Further features and advantages of the invention will emerge from reading the description of exemplary embodiments of a headlamp according to the invention with reference to the attached drawings, in which:

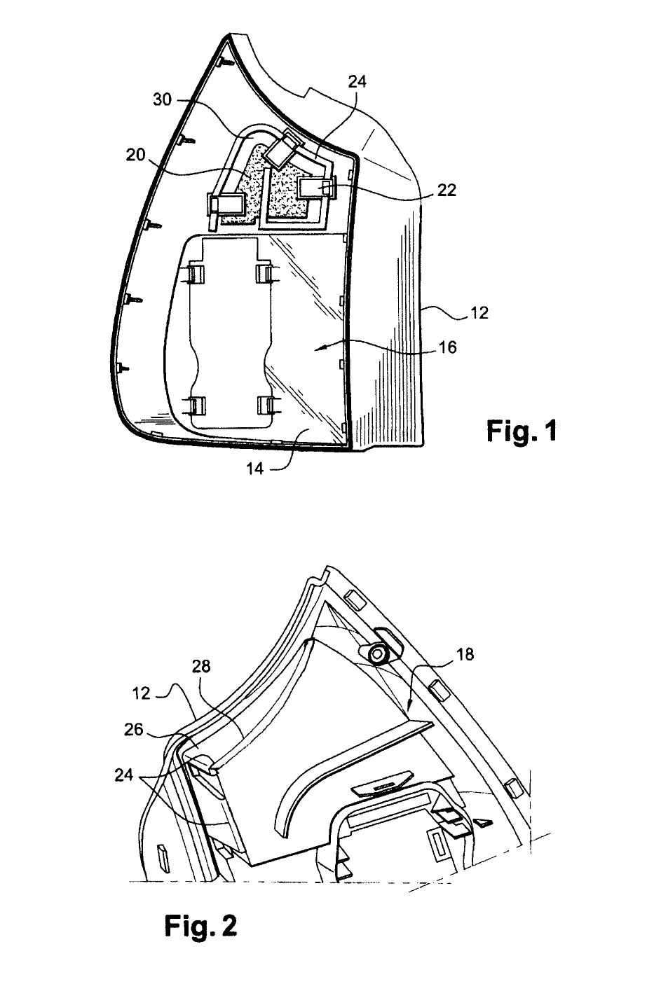

FIG. 1 is a front view of a headlamp housing according to the invention; and

FIG. 2 is a rear view of the headlamp housing of FIG. 1.

As shown in FIG. 1, a motor vehicle headlamp comprises a housing 12 intended to be fixed to a bodywork component (not shown) of the vehicle. The housing 12 comprises an end wall 14 having a front face 16 facing the vehicle exterior and a rear face 18 facing the vehicle interior.

The housing 12 contains lighting means (not shown) consisting of LEDs and power supply means for these diodes comprising a printed circuit board 20.

The printed circuit board 20 is held secured to the front face 16 of the end wall 14 of the housing 12 by way of tabs 22.

Part of the contents of the housing 12, namely the power supply means comprising the printed circuit board 20, is concealed by what is known as a mask (not shown) which is fixed on the housing 12.

The housing and the mask are covered by a lens fixed on the housing 12.

When the components of the headlamp need to be separated with a view to recycling the vehicle at the end of its life, it is thus difficult to separate the printed circuit board 20 from the housing 12, which is inaccessible without completely disassembling the headlamp.

To this end, an area 24 of the end wall 14, situated at the periphery of the portion of the end wall bearing the printed circuit board 20, is thinner than the rest of the wall 14 so as to form a fracture initiation area.

Therefore, when the printed circuit board 20 is located in an indentation 26, the fracture initiation area 24 is situated on at least one edge 28 of the indentation 26.

As shown in FIG. 1, the fracture initiation area 24 runs at least partly along the periphery of the portion 30 of the end wall 14 bearing the printed circuit board 20.

Therefore, when an operator disassembles the headlamp for recycling purposes, in a first step he detaches the headlamp from the body of the vehicle, then in a second step he uses, for example, a tool such as a hammer to strike the rear face 18 of the end wall 14 of the headlamp housing 12, in the fracture initiation area 24. In the case shown here, where the fracture initiation area 24 runs only partly along the periphery of the portion of the end wall bearing the board 20, the strike causes the end wall 14 to partly open, thus making it possible, in a third step, to slide the printed circuit board 20 so as to disengage it from the tabs 22 and then to extract it from the housing 12.

When the fracture initiation area 24 runs around the entire periphery of the portion 30 of the wall, the operator's strike causes said portion 30 to be disconnected so that said board 20 can be extracted from the housing 12.

In the second step, by exerting pressure on the portion of the wall bearing the printed circuit board, it is possible to disconnect said portion of the wall.

The exemplary embodiment described here relates to a printed circuit board, but the invention could also be applied to any attached component borne by the end wall and needing to be separated from the rest of the headlamp with a view to recycling it.

1-5. (canceled)

6. A motor vehicle headlamp comprising:
a housing containing light-emitting diodes and at least one printed circuit board forming part of a power supply for the diodes, the printed circuit board being held against a front face of an end wall of the housing,
wherein a portion of the end wall bearing the printed circuit board is at least partly delimited by a fracture initiation area.

7. The motor vehicle headlamp as claimed in claim 6, wherein the fracture initiation area includes a thinning of the thickness of the end wall.

8. The motor vehicle headlamp as claimed in claim 6, wherein the printed circuit board is located in an indentation in the end wall, and the fracture initiation area is formed by at least one edge of the indentation.

9. The motor vehicle headlamp as claimed in claim 7, wherein the printed circuit board is located in an indentation in the end wall, and the fracture initiation area is formed by at least one edge of the indentation.

10. A method for separating components of a headlamp as claimed in claim 6, comprising:
detaching the headlamp from the vehicle;
applying a force to the rear face of the end wall of the housing, near the printed circuit board, until the fracture initiation area gives way; and
withdrawing the printed circuit board from the housing through the opening created in the rear of the end wall of the housing.

11. The method for separating components as claimed in claim 10, wherein in the applying the fracture initiation area is struck directly.
